(19) United States
(12) Patent Application Publication
(10) Pub. No.: US 2020/0271856 A1
(43) Pub. Date: Aug. 27, 2020

(54) POLYMER OPTICAL WAVEGUIDE

(71) Applicant: AGC Inc., Chiyoda-ku (JP)

(72) Inventors: Kenta KOBAYASHI, Tokyo (JP); Shotaro TAKENOBU, Tokyo (JP)

(73) Assignee: AGC Inc., Chiyoda-ku (JP)

(21) Appl. No.: 16/790,859

(22) Filed: Feb. 14, 2020

(30) Foreign Application Priority Data
Feb. 22, 2019 (JP) 2019-030089

(51) Int. Cl. G02B 6/02

(52) U.S. Cl. CPC G02B 6/02038

(57) ABSTRACT

The present invention provides a polymer optical waveguide containing a core and a cladding having a refractive index lower than that of the core, in which each of the core and the cladding is a cured product of a curable composition cured by light irradiation, and the cladding has an absorbance of 0.23 or low per 50 μm of film thickness at a wavelength of 365 nm.

### TECHNICAL FIELD

The present invention relates to a polymer optical waveguide.

### BACKGROUND

For example, in the field of communication devices, with miniaturization of the devices and speeding-up of communication, it is attracting attention to use a resin-made polymer optical waveguide for signal transmission (see Patent Document 1).

A polymer optical waveguide is produced, for example, by the following procedure.
(1) A curable composition is applied on a substrate and is cured by performing light irradiation to form an under-cladding.
(2) A coated film of a curable composition is formed on the under-cladding and then, the coated film is processed by a photolithography process to form a core.
(3) A curable composition is applied on the under-cladding and on the core and is cured by performing light irradiation to form an over-cladding.
Patent Document 1: Japanese Patent No. 5459310

### SUMMARY

In the polymer optical waveguide produced by the above procedure, exfoliation of the core at the interface with the under-cladding is prone to be a problem. The exfoliation of the core at the interface with the under-cladding causes such a problem of disconnection of the produced polymer optical waveguide and hence is problematic.

In order to solve the problem of the conventional art described above, an object of the present invention is to provide a polymer optical waveguide in which the exfoliation of the core at the interface with the cladding is suppressed.

In order to achieve the object described above, the present invention provides a polymer optical waveguide containing a core and a cladding having a refractive index lower than that of the core, in which each of the core and the cladding is a cured product of a curable composition cured by light irradiation, and the cladding has an absorbance of 0.23 or low per 50 μm of film thickness at a wavelength of 365 nm.

Moreover, the present invention provides a polymer optical waveguide containing a core and a cladding having a refractive index lower than that of the core, in which each of the core and the cladding is a cured product of a curable composition cured by light irradiation, and the cladding has a transmittance of 59% or more per 50 μm of film thickness at a wavelength of 365 nm.

In the polymer optical waveguide of the present invention, the exfoliation of the core at the interface with the cladding is suppressed.

### EMBODIMENTS

The following will explain an embodiment of the polymer optical waveguide of the present invention.

The polymer optical waveguide of the present embodiment contains a core and a cladding having a refractive index lower than that of the core. The core and the cladding are formed by curing a curable composition (curable resin) by light irradiation. For the light irradiation to be performed for this purpose, i-line having a central wavelength of 365 nm has been widely used.

The present inventors have found that i-line absorption properties of the cladding influences easiness of the exfoliation of the core at the interface with the cladding. Namely, in the case where the cladding is prone to absorb i-line, the curing of the cladding may become insufficient at the time of the formation of the cladding in some cases. In other words, in the case where the cladding has high i-line absorption properties, light absorption by a photoinitiator in the curable composition (curable resin) is inhibited, curing reaction of the curable composition (curable resin) may be difficult to occur, and as a result, the cladding may remain uncured in some cases. When the core is formed on the cladding in this state, close adhesion of the core at the interface with the cladding may become insufficient and thus the exfoliation of the core at the interface with the cladding is prone to occur.

With regard to the i-line absorption properties of the cladding, the present inventors have focused on the absorbance per 50 μm of film thickness at a wavelength of 365 nm. The reason why attention has paid to the absorbance per 50 μm of film thickness is that the evaluation of the absorbance is easy.

In the polymer optical waveguide of the first embodiment of the present invention, absorbance of the cladding per 50 μm of film thickness at a wavelength of 365 nm is 0.23 or low. In this case, since the absorption of i-line at the cladding is small, the curable composition (curable resin) is sufficiently cured at the time of the formation of the cladding. When a core is formed on the cladding in this state, the core is sufficiently closely adhered to the interface with the cladding, so that the exfoliation of the core at the interface with the cladding is suppressed.

Incidentally, the absorbance of the cladding per 50 μm of film thickness at a wavelength of 365 nm can be measured, for example, by a spectrophotometer.

The absorbance and transmittance of the polymer optical waveguide of the present invention are measured after curing of the curable composition but similar numeral values are observed even for the curable composition before curing.

In the polymer optical waveguide of the present embodiment, the absorbance of the cladding per 50 μm of film thickness at a wavelength of 365 nm is preferably 0.22 or low, more preferably 0.21 or low, and further preferably 0.18 or low.

With regard to the i-line absorption properties, attention may be paid to the transmittance of the cladding per 50 μm of film thickness at a wavelength of 365 nm instead of the absorbance per 50 μm of film thickness at a wavelength of 365 nm.

In the polymer optical waveguide of the second embodiment of the present invention, the transmittance of the cladding per 50 μm of film thickness at a wavelength of 365 nm is 59% or more. In this case, since the absorption of i-line at the cladding is small, the curable composition (curable resin) is sufficiently cured at the time of the formation of the cladding. When a core is formed on the cladding in this state, the core is sufficiently closely adhered to the interface with the cladding, so that the exfoliation of the core at the interface with the cladding is suppressed.

Incidentally, the transmission of the cladding per 50 μm of film thickness at a wavelength of 365 nm can be measured, for example, by a spectrophotometer.

In the polymer optical waveguide of the present embodiment, the transmittance of the cladding per 50 μm of film thickness at a wavelength of 365 nm is preferably 60% or more, more preferably 61% or more, and further preferably 65% or more.

In the polymer optical waveguide of the embodiments of the present invention, not all portions of the cladding may be required to satisfy the aforementioned absorbance per 50 μm of film thickness at a wavelength of 365 nm or the aforementioned transmittance per 50 μm of film thickness at a wavelength of 365 nm.

In the polymer optical waveguide of the present invention, the cladding preferably contains an under-cladding present around the core at one side and an over-cladding present around the core at the opposite side to the under-cladding.

In the case where the polymer optical waveguide having the above-described configuration is produced by the above-exemplified procedure, the core is formed on the under-cladding. Therefore, in the case where the under-cladding satisfies the aforementioned absorbance per 50 μm of film thickness at a wavelength of 365 nm or the aforementioned transmittance per 50 μm of film thickness at a wavelength of 365 nm, the exfoliation of the core at the interface with the cladding is suppressed. In this case, the over-cladding may not satisfy the aforementioned absorbance per 50 μm of film thickness at a wavelength of 365 nm or the aforementioned transmittance per 50 μm of film thickness at a wavelength of 365 nm.

However, since the under-cladding and the over-cladding are mere terms regarding the constituting elements of a polymer optical waveguide, it is also possible that a core is formed on a portion to be an over-cladding, then a portion to be an under-cladding is formed, and thereafter, the whole is turned upside down to obtain a configuration of the under-cladding, the core, and the over-cladding. In this case, when the over-cladding satisfies the aforementioned absorbance per 50 μm of film thickness at a wavelength of 365 nm or the aforementioned transmittance per 50 μm of film thickness at a wavelength of 365 nm, the exfoliation of the core at the interface with the cladding is suppressed. In this case, the under-cladding may not satisfy the aforementioned absorbance per 50 μm of film thickness at a wavelength of 365 nm or the aforementioned transmittance per 50 μm of film thickness at a wavelength of 365 nm.

On the other hand, in the case of a polymer optical waveguide for use in adiabatic-coupling with a silicon optical waveguide as in the case of the polymer optical waveguides described in WO2017/022719 and WO2017/022717, a core-exposed section at which an over-cladding is not present and a core and an under-cladding around the core are exposed is provided on at least a part of the portion at which adiabatic-coupling is achieved with the silicon optical waveguide. In this case, the under-cladding at the core-exposed section may satisfy the aforementioned absorbance per 50 μm of film thickness at a wavelength of 365 nm or the aforementioned transmittance per 50 μm of film thickness at a wavelength of 365 nm.

The polymer optical waveguide of the present invention will be further described.

In the polymer optical waveguide of the present invention, constituting materials of the core and the cladding are not particularly limited as long as they are curable compositions causing difference in refractive index so that the refractive index of the cladding is lower than that of the core. For example, use can be made of various resin materials, e.g., acrylic resins, methacrylic resins such as polymethyl methacrylate (PMMA), epoxy resins, oxetane resins, phenoxy resins, benzocyclobutene resins, norbornen resins, fluorine resins, silicone resins, phenol resins, polyester resins, polycarbonate resins, polystyrene resins, polyamide resins, polyimide resins such as polyimide resins, poly(imide-isoindoloquinazolinedionimide) resins, polyether imide resins, polyether ketone resins, and polyester imide resins, polybenzoxazole resins, polysilanes, and polysilazane-imidazole resins, and organic and inorganic hydride materials.

Of these materials, fluorine resins are suitable as materials of the core and the cladding owing to low water absorption or moisture absorption, excellent resistance to high temperature and high humidity, and high chemical stability. The polymer optical waveguide using a fluorine resin shows stable properties with small variation in refractive index caused by change in external environment, particularly change in humidity and also exhibits high transparency in the optical communication wavelength band.

The constituting materials of the core and cladding of the polymer optical waveguide are not particularly limited as long as they satisfy required properties as a polymer optical waveguide but it is preferable to use materials described in the following.

It is preferable that at least one of the core and the cladding is formed by curing a fluorine-containing polyarylene prepolymer (A) having a crosslinkable functional group (hereinafter sometimes simply referred to as “prepolymer (A)”).

### Suitable Examples of Constituting Material of Core:

A suitable example of the constituting material of the core is a fluorine-containing polyarylene prepolymer (A) having a crosslinkable functional group. The core may be formed by curing the prepolymer (A).

The curing method may be heat or light and light irradiation is more preferred.

The prepolymer (A) has a polyarylene structure in which a plurality of aromatic rings are bonded through a single bond or a linking group, and also has a fluorine atom and a crosslinkable functional group.

Examples of the linking group in the polyarylene structure include an ether bond (—O—), a sulfide bond (—S—), a carbonyl group (—CO—), a bivalent group (—SO₂—) obtained by removing a hydroxyl group from a sulfonic acid group, and the like. Of the prepolymers (A), in particular, one having a structure in which aromatic rings are bonded each other through a linking group containing an ether bond (—O—) is particularly referred to as a fluorine-containing polyarylene ether prepolymer (A1). The prepolymer (A) herein is a concept including the fluorine-containing polyarylene ether prepolymer (A1).

Specific examples of the linking group containing an ether bond include an ether bond (—O—) composed of an ethereal oxygen atom alone, an alkylene group containing an ethereal oxygen atom in the carbon chain, and the like.

The crosslinkable functional group of the prepolymer (A) may be a reactive functional group which does not substantially cause any reaction at the time of preparing the prepolymer but causes reaction by light irradiation to cause an increase in molecular weight through crosslinking or chain extension between the prepolymer molecules. As mentioned above, for the light irradiation, i-line having a central wavelength of 365 nm has been widely used.

Specific examples of the crosslinkable functional group include a vinyl group, an allyl group, an allyloxy group, a methacryloyl(oxy) group, an acryloyl(oxy) group, a vinyloxy group, a trifluorovinyl group, a trifluorovinyloxy group, an ethylyl group, a 1-oxocyclopenta-2,5-diene-3-yl group, a cyano group, an alkoxysilyl group, a diarylhydroxymethyl group, a hydroxyfluorenyl group, a cyclobutalene ring, an oxirane ring, and the like. In view of high reactivity and achievement of high crosslinking density, preferred are a vinyl group, a methacryloyl(oxy) group, an acryloyl(oxy) group, a trifluorovinyloxy group, an ethylyl group, a cyclobutalene ring, and an oxirane ring. In view of good thermal resistance after the increase in molecular weight, most preferred are a vinyl group and an ethynyl group.

Incidentally, the methacryloyl(oxy) group means a methacryloyl group or a methacryloyloxy group. The same shall apply to the acryloyl(oxy) group.

Since the prepolymer (A) has an aromatic ring, thermal resistance is satisfactory.

Of the prepolymers (A), the fluorine-containing polyarylene ether prepolymer (A1) has an ethereal oxygen atom and hence its molecular structure has flexibility, so that the compound is preferred in view of good flexibility of the cured product.

The prepolymer (A) has a fluorine atom. Namely, the prepolymer (A) has a C—F bond in which the hydrogen atom of a C—H bond is replaced by a fluorine atom, so that the existing ratio of the C—H bond is decreased. Since the C—H bond has absorption in the optical communication wavelength band (1,250 nm to 1,650 nm), the prepolymer (A) having a less amount of C—H bond can suppress absorption of light in the optical communication wavelength band. Moreover, since the prepolymer (A) has a fluorine atom, the compound shows low water absorption or moisture absorption, excellent resistance to high temperature and high humidity, and high chemical stability. Therefore, a polymer optical waveguide using the prepolymer (A) shows stable properties with small variation in refractive index caused by change in external environment, particularly change in humidity and also exhibits high transparency in the optical communication wavelength band.

In addition, since a cured product of the prepolymer (A) has high transparency in the vicinity of a wavelength of 1,310 nm, the prepolymer (A) can provide a polymer optical waveguide having good compatibility with already-existing optical elements. Namely, in general, since a wavelength of 1,310 nm is frequently used in an optical transmission device using a quartz-based optical fiber, many optical elements such as light receiving elements compatible to this wavelength have been produced and thus reliability is high.

Preferred examples of the prepolymer (A) include polymers obtained by reacting a fluorine-containing aromatic compound such as perfluoro(1,3,5-triphenylbenzene) or perfluorobiphenyl; a phenol compound such as 1,3,5-trihydroxybenzne or 1,1,1-tris(4-hydroxyphenyl)ethane; and a crosslinkable compound such as pentafluorostyrene, acetoxystyrene or chloromethyl styrene, in the presence of a dehydrohalogenation agent such as potassium carbonate.

The content of the crosslinkable functional group in the prepolymer (A) is preferably from 0.1 to 4 mmol, more preferably from 0.2 to 3 mmol of the crosslinkable functional group per 1 g of the prepolymer (A). In the case where the content is controlled to 0.1 mmol or more, thermal resistance and solvent resistance of the cured product can be made sufficiently high. In the case where the content is controlled to 4 mmol or less, brittleness can be controlled to be sufficiently low and an increase in specific dielectric constant can be suppressed.

The curable composition for constituting the core may contain other components than the curable resin or prepolymer (A). Examples of the other components include various additives such as a photosensitizer and solvents, which are widely used in this art field, as well as unreacted raw materials such as monomer compounds and dehydrohalogenation agent. The respective contents of the other components are not particularly limited as long as they do not impair the effect of the present invention. Moreover, one kind or two or more kinds of the prepolymer (A) may be used in the curable composition for constituting the core.

### Suitable Examples of Constituting Material of Cladding:

A suitable example of the constituting material of the cladding is a curable composition (I) which contains: a compound (B) having a molecular weight of 140 to 5,000, having a crosslinkable functional group, and having no fluorine atom; and the prepolymer (A) described above. The cladding may be formed by curing the curable composition (I).

The curing method may be heat or light and light irradiation is more preferred.

Incidentally, the prepolymer (A) to be used in the curable composition (I) may be the same as or different from the prepolymer (A) to be used for the formation of the core. In view of bonding property, close adhesiveness, crack suppression, or reduction in expansion coefficient, they are preferably the same. Moreover, one kind or two or more kinds of the prepolymer (A) may be used in the curable composition (I).

Since the compound (B) described above does not have any fluorine atom, good embedding flatness is easily obtained. In the case where the embedding flatness is good, the surface of the over-cladding is prone to become flat at the time of producing a polymer optical waveguide. Moreover, the cost may tend to be low as compared with the case of a fluorine-containing compound.

In the case where the molecular weight of the compound (B) is 5,000 or less, viscosity of the compound (B) is suppressed to low and a homogeneous composition is easily obtained at the time of mixing the compound (B) with the prepolymer (A). Moreover, good flatness is easily attained.

In the case where the molecular weight of the compound (B) is 140 or more, good thermal resistance is attained and thus decomposition and evaporation due to heating hardly occur. The range of the molecular weight of the compound (B) is preferably from 250 to 3,000 and particularly preferably from 250 to 2,500.

The crosslinkable functional group of the compound (B) is preferably a reactive functional group which contains no fluorine atom and causes reaction in the same step as the step of reacting the crosslinkable functional group of the prepolymer (A).

The crosslinkable functional group of the compound (B) reacts with at least the compound (B) to cause crosslinking or chain extension. The crosslinkable functional group of the compound (B) preferably reacts with both of the prepolymer (A) and the compound (B) to cause crosslinking or chain extension.

Preferred examples of the crosslinkable functional group of the compound (B) include a carbon-carbon double bond or a carbon-carbon triple bond. However, aromatic double bond and triple bond are not included.

The double bond and triple bond as the crosslinkable functional group may be present inside the molecular chain or may be present at the terminal, and is preferably present at the terminal owing to high reactivity. In the case of the double bond, it may be an internal olefin or a terminal olefin and is preferably a terminal olefin. The presence of the double bond inside the molecular chain includes the presence of the double bond in a part of an aliphatic ring, such as a cycloolefin.

Specifically, the compound (B) preferably has one or more crosslinkable functional groups selected from the group consisting of a vinyl group, an allyl group, an ethynyl group, a vinyloxy group, an allyloxy group, an acryloyl group, an acryloyloxy group, a methacryloyl group, and a methacryloyloxy group. Of these, an acryloyl group and an acryloyloxy group are preferred since they can cause reaction by light irradiation even in the absence of a photosensitizer.

The compound (B) has preferably two or more crosslinkable functional groups, more preferably 2 to 20 crosslinkable functional groups, and particularly preferably 2 to 8 crosslinkable functional groups. In the case where the compound (B) has two or more crosslinkable functional groups, crosslinking between molecules can be achieved, so that thermal resistance of the cured film can be improved and reduction in film thickness by heating in the cured film can be satisfactorily suppressed.

Specific examples of the compound (B) include dipentaerythritol triacrylate triundecylate, dipentaerythritol pentaacrylate monoundecylate, ethoxylated isocyanuric acid triacrylate, c-caprolactone-modified tris-(2-acryloxyethyl) isocyanurate, dipentaerythritol polyacrylate, 9,9-bis[4-(2-acryloyloxyethoxy)phenyl]fluorene, polyethylene glycol diacrylate, polyethylene glycol dimethacrylate, polypropylene glycol diacrylate, polypropylene glycol dimethacrylate, ethoxylated bisphenol A diacrylate, ethoxylated bisphenol A dimethacrylate, propoxylated bisphenol A diacrylate, propoxylated bisphenol A dimethacrylate, 1,10-decanediol diacrylate, 1,6-hexanediol diacrylate, 1,6-hexanediol dimethacrylate, 1,4-butanediol dimethacrylate, 1,3-butanediol dimethacrylate, hydroxypivalic acid neopentyl glycol diacryalte, 1,9-nonanediol diacryalte, 1,9-nonanediol dimethacryalte, neopentyl glycol diacryalte, neopentyl glycol dimethacryalte, pentaerythritol triacrylate, trimethylolpropane triacrylate, ethoxylated trimethylolpropane triacryalte, propoxylated trimethylolpropane triacryalte, triallyl cyanurate, triallyl isocyanurate, trimethallyl isocyanurate, 1,4-butanediol divinyl ether, 1,9-nonanediol divinyl ether, cyclohexanedimethanol divinyl ether, triethylene glycol divinyl ether, trimethylolpropane trivinyl ether, pentaerythritol tetravinyl ether, 2-(2-vinyloxyethoxy)ethyl acrylate, 2-(2-vinyloxyethoxy)ethyl methacrylate, trimethylolpropane diallyl ether, pentaerythritol triallyl ether, dipentaerythritol hexaacryl ate, pentaerythritol tetraacrylate, ethoxylated pentaerythritol tetraacrylates represented by the following formula (1), propoxylated pentaerythritol tetraacrylates represented by the following formula (2), ditrimethylolpropane tetraacrylate, tricyclodecanedimethanol diacrylate, tricyclodecanedimethanol methacrylate, compounds represented by the following formula (3), and the like. Moreover, use can be also made of polyester acrylates (compounds in which both terminals of a condensate of a divalent alcohol and a dibasic acid are modified with acrylic acid: e.g., trade name ARONIX (M-6100, M-6200, M-6250, M-6500), manufactured by Toagosei Co., Ltd.); compounds in which hydroxyl group-terminals of a condensate of a polyhydric alcohol with a polybasic acid are modified with acrylic acid: e.g., trade name ARONIX (M-7100, M-7300K, M-8030, M-8060, M-8100, M-8530, M-8560, M-9050), manufactured by Toagosei Co., Ltd., etc.). They are available as commercially available products.

Of those described above, polypropylene glycol dimethacrylate and 1,10-decanediol diacrylate are preferred because of good formability of the cured film.

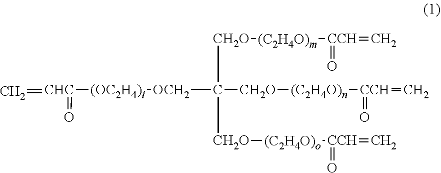

(In the formula (1), 1+m+n+o is from 4 to 35.)

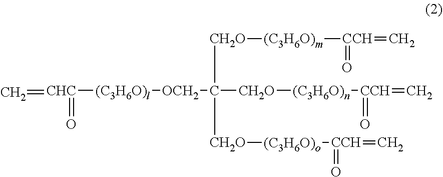

(In the formula (2), 1+m+n+o is about 4.)

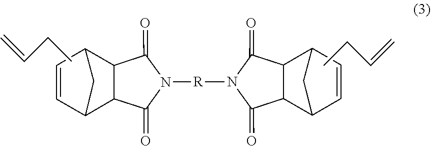

(In the formula (3), R is

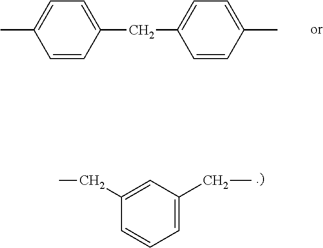

Since the cured product of the curable composition (I) forms a cladding, it is necessary that the refractive index of the cured product of the curable composition (I) is lower than that of the core. The refractive index of the cured product of the curable composition (I) can be adjusted by the kind of the compound (B) and the mixing ratio of the prepolymer (A) to the compound (B).

Among the exemplified compounds (B) listed above, in the case of using a compound where the refractive index of the cured product obtained by curing the compound alone is lower than the refractive index of the cured product obtained by curing the prepolymer (A) alone, the refractive index of the cured product of the curable composition (I) can be made lower than that of the cured product of the prepolymer (A) by blending the compound into the prepolymer (A).

Among the exemplified compounds (B) listed above, in the case of using a compound where the refractive index of the cured product obtained by curing the compound alone is equal to or higher than the refractive index of the cured product obtained by curing the prepolymer (A) alone, the refractive index of the cladding can be made lower than that of the core by using the compound in combination with another compound (B) where the refractive index of the cured product obtained by curing the compound alone is lower than the refractive index of the cured product obtained by curing the prepolymer (A) alone.

Since the curable composition (I) contains the compound (B) having a relatively low molecular weight, the curable composition (I)easily becomes a homogeneous composition and is prone to afford a flat surface at the time of curing. Moreover, the compound (B) causes a crosslinking reaction and hence contributes to good thermal resistance.

The ratio of the prepolymer (A) contained in the curable composition (I) to the total mass of the prepolymer (A) and the compound (B) is preferably from 1 to 97% by mass, more preferably from 5 to 50% by mass, and further preferably from 8 to 35% by mass.

A larger content ratio of the prepolymer (A) tends to afford higher thermal resistance. A larger content ratio of the compound (B) tends to afford better flatness of the cured product surface.

The curable composition (I) can be also prepared by dissolving the prepolymer (A) and the compound (B) in a solvent. In this case, a known solvent can be used. Specific examples of the solvent include propylene glycol monomethyl ether acetate (hereinafter also referred to as PGMEA), ethyl acetate, propyl acetate, isopropyl acetate, butyl acetate, pentyl acetate, isopentyl acetate, isobutyl isobutyrate, methyl-3-methoxypropionate, dipropylene glycol methyl ether acetate, cyclopentanone, methyl ethyl ketone, methyl isobutyl ketone, dibutyl ketone, and the like.

The curable composition (1) may contain a photosensitizer. Specific examples of the photosensitizer include IRGACURE 907 (α-aminoalkylphenone type), IRGACURE 36 (α-aminoalkylphenone type), DAROCUR TPO (acylphosphine oxide type), IRGACURE OXE01 (oxime ester derivative), and IRGACURE OXE02 (oxime ester derivative) (all manufactured by Ciba Specialty Chemicals), and the like. Of these, DAROCUR TPO, IRGACURE OXE01 and IRGACURE OXE02 are especially preferred.

However, too large content of the photosensitizer influences the i-line absorption properties of the cladding to be formed, and there arise such problems that the absorbance per 50 μm of film thickness at a wavelength of 365 nm is increased or the transmittance per 50 μof film thickness at a wavelength of 365 nm is lowered, so that attention should be paid. The content of the photosensitizer is preferably 10% by mass or less and more preferably 5% by mass or less with respect to the curable composition (I).

As other factors that influence the i-line absorption properties of the cladding to be formed, contamination of a metal compound and/or air bubbles may be mentioned. In the occurrence of such a contamination, there arise such problems that the absorbance per 50 μm of film thickness at a wavelength of 365 nm is increased or the transmittance per 50 μm of film thickness at a wavelength of 365 nm is lowered, so that attention should be paid. The content of the metal compound is preferably 30 ppm by mass or less and more preferably 15 ppm by mass or less. In addition, the curable composition (I) preferably contains no air bubbles having a size of 8 μm or larger and more preferably contains no air bubbles having a size of 2 μm or larger.

### Production Procedure of Polymer Optical Waveguide:

The production method of the polymer optical waveguide of the present invention is not particularly limited and a variety of methods can be used. Specifically, use can be made of a duplication (stamper) method, a direct exposure method, a method of combining a reactive ion etching (RIE) and a photolithography process, a method based on an injection molding, a photobleaching method, a direct drawing method, a self-forming method, and the like.

An example of the production method of the polymer optical waveguide of the present invention will be described.

First, a coating solution containing a curable composition (A) that is a constituting material of an under-cladding is applied on a substrate by a spin coating method. Subsequently, the curable composition (A) is cured by light irradiation to form an under-cladding.

Next, a coating solution containing a curable composition (B) that is a constituting material of a core is applied on the under-cladding by a spin coating method. Subsequently, the curable composition (B) is patterned by a photolithography process to form a core on the under-cladding. At this time, for forming such a shape that the width of the core differs along the light propagation direction, the applied coating solution may be exposed to light by using a photomask having such the shape that the width of the opening differs along the light propagation direction, and then developed to form the core. Moreover, after the core is formed, post-baking may be performed when needed.

Then, a coating solution containing a curable composition (C) that is a constituting material of an over-cladding is applied on the under-cladding and the core by a spin coating method. Subsequently, the curable composition (C) is cured by light irradiation to form an over-cladding. At the time of forming the over-cladding, a core-exposed section at which the over-cladding is not present and the core and the under-cladding around the core are exposed can be formed by a photolithography process.

The polymer optical waveguide of the present invention is preferably a single-mode polymer optical waveguide.

### EXAMPLES

The following will describe the present invention in further detail with reference to Examples. However, the present invention should not be construed as being limited to these Examples.

### Examples 1 to 6

In Examples 1 to 6, polymer optical waveguides were manufactured by the procedure described in the following. Of Examples 1 to 6, Examples 1 to 4 are Working Examples and Examples 5 and 6 are Comparative Examples.

### Preparation Procedure of Core-Forming Material and Cladding-Forming Material:

A curable composition (I-1) for use in core formation was prepared by the following procedure.

In a solvent of N,N-dimethylacetamide (hereinafter referred to as DMAc), perfluorobiphenyl (67% by mass) and 1,3,5-trihydroxybenzene (12% by mass) were reacted at an average temperature A shown in the following Table 1 for 5 hours in the presence of potassium carbonate. Subsequently, thereto was added 4-acetoxystyrene (21% by mass) and, the mixture was reacted in the presence of an aqueous potassium hydroxide solution while cooling to the average temperature B shown in the following Table 1, thereby synthesizing a prepolymer. The obtained DMAc solution of the prepolymer was charged into an aqueous hydrochloric acid solution to perform reprecipitation purification, followed by vacuum drying, to thereby obtain a powdery prepolymer. Then, in 70% by mass of polypropylene glycol methyl ether acetate was dissolved 30% by mass of the powdery prepolymer, followed by stirring at room temperature for 55 hours, to thereby prepare the curable composition (I-1).

Curable compositions (I-2) and (I-3) for use in cladding formation were prepared by the following procedure.

In 50% by mass of polypropylene glycol methyl ether acetate was dissolved 40% by mass of the powdery prepolymer obtained by the above procedure together with 10% by mass of polypropylene glycol dimethacrylate, followed by stirring at room temperature for 55 hours, to thereby obtain the curable compositions (I-2) and (I-3).

Incidentally, as for the curable composition (I-1) used in the present Example, the average temperature A at the time of preparation is preferably 41° C. or lower, more preferably from 30° C. to 41° C., and further preferably from 38° C. to 41° C.

### Manufacturing Procedure of Polymer Optical Waveguide:

The curable composition (I-2) that was a constituting material of an under-cladding was applied on a substrate by a spin coating method. Subsequently, the curable composition (I-2) was cured by light irradiation to form an under-cladding so as to have a film thickness of 50 μm.

Next, the curable composition (I-1) that was a constituting material of a core was applied on the under-cladding by a spin coating method. Subsequently, the curable composition (I-1) was patterned by a photolithography process to form a core having a portion whose thickness ranged from 2.0 to 3.0 μm and whose width ranged from 2.0 to 10.0 μm the under-cladding.

Then, the curable composition (I-3) that was a constituting material of an over-cladding was applied on the under-cladding and the core by a spin coating method. Subsequently, the curable composition (I-3) was cured by light irradiation to form an over-cladding so as to have a film thickness of from 20 to 25 μm.

Finally, in order to stabilize the shape, post-baking was carried out under N₂ atmosphere, to thereby manufacture a polymer optical waveguide.

For the manufactured polymer optical waveguide, absorbance and transmittance of the cladding per 50 μm of film thickness at a wavelength of 365 nm was measured by the procedure described in the following.

### Measurement of Absorbance and Transmittance of Cladding per 50 μm of Film Thickness:

For the measurement of the absorbance and transmittance, the cladding portion was measured at a measuring range diameter ϕ of 50 μm by using a microscopic ultraviolet-visible/near-infrared spectrophotometer (Product Model MSV5200, manufactured by JASCO Corporation).

For the measurement of film thickness at the measurement place, a white interferometer (Product Model: three-dimensional optical profiler system Newview 7300, manufactured by ZYGO) was used. A 20-magnification objective lens was used.

The absorbance and transmittance per 50 μm of film thickness were calculated from the absorbance and transmittance measured on the microscopic ultraviolet-visible/near-infrared spectrophotometer based on the film thickness measured on the white interferometer.

In addition, for each Example, 100 samples of the polymer optical waveguide were manufactured, whether exfoliation of the core was occurred or not was visually observed, and evaluation was performed according to the following criteria.
A: occurrence of exfoliation at 9 or less samples
B: occurrence of exfoliation at 10 to 19 samples
C: occurrence of exfoliation at 20 or more samples.

TABLE 1

| Example | 1 | 2 | 3 | 4 | 5 | 6 |
|---|---|---|---|---|---|---|
| Absorbance per 50 μm | 0.212 | 0.183 | 0.221 | 0.212 | 0.236 | 0.310 |
| film thickness (λ 365 nm) | | | | | | |
| Transmittance per 50 μm film | 61.43 | 65.54 | 60.15 | 61.39 | 58.07 | 48.97 |
| thickness (λ 365 nm) Unit: (%) | | | | | | |
| Evaluation on core exfoliation | A | A | A | A | B | C |
| Average temperature A (° C.) | 38.5 | 38 | 40.5 | 39 | 42 | 44 |
| Average temperature B (° C.) | 3 | 3 | 3 | 3 | 5 | 5 |

The evaluation of core exfoliation was A in Examples 1 to 4 where the absorbance of the cladding per 50 μm of film thickness at a wavelength of 365 nm was 0.23 or low and the transmittance of the cladding per 50 μm of film thickness at a wavelength of 365 nm was 59% or more. On the other hand, the evaluation of core exfoliation was B or C in Examples 5 and 6 where the absorbance of the cladding per 50 μm of film thickness at a wavelength of 365 nm was higher than 0.23 and the transmittance of the cladding per 50 μm of film thickness at a wavelength of 365 nm was less than 59%.

While the present invention has been described with reference to certain exemplary embodiments thereof, the scope of the present invention is not limited to the exemplary embodiments described above, and it will be appreciated by those skilled in the art that various changes and modifications may be made therein without departing from the scope of the present invention as defined by the appended claims.

The present application is based on Japanese Patent Application No. 2019-030089 filed on Feb. 22, 2019, the contents thereof being hereby incorporated by reference.

1. A polymer optical waveguide comprising a core and a cladding having a refractive index lower than that of the core, wherein
each of the core and the cladding is a cured product of a curable composition cured by light irradiation, and
the cladding has an absorbance of 0.23 or low per 50 μm of film thickness at a wavelength of 365 nm.

2. The polymer optical wave guide according to claim 1, wherein
the cladding comprises an under-cladding present around the core at one side and an over-cladding present around the core at the opposite side to the under-cladding, and
at least one of the under-cladding and the over-cladding has an absorbance of 0.23 or low per 50 μm of film thickness at a wavelength of 365 nm.

3. The polymer optical wave guide according to claim 2, at least partially having a section at which one of the under-cladding and the over-cladding is not present and a core and the other cladding around the core are exposed, wherein
the other cladding in the section has an absorbance of 0.23 or low per 50 μm of film thickness at a wavelength of 365 nm.

4. The polymer optical wave guide according to claim 1, wherein
the curable composition of at least one of the core and the cladding comprises a fluorine-containing polyarylene prepolymer (A) having a crosslinkable functional group.

5. The polymer optical wave guide according to claim 4 wherein
the curable composition of the core comprises the fluorine-containing polyarylene prepolymer (A) having a crosslinkable functional group, and
the curable composition of the cladding comprises: the fluorine-containing polyarylene prepolymer (A) having a crosslinkable functional group; and a compound (B) having a molecular weight of 140 to 5,000, having a crosslinkable functional group, and having no fluorine atom.

6. The polymer optical waveguide according to claim 1, being a single-mode polymer optical waveguide.

7. A polymer optical waveguide comprising a core and a cladding having a refractive index lower than that of the core, wherein
each of the core and the cladding is a cured product of a curable composition cured by light irradiation, and
the cladding has a transmittance of 59% or more per 50 μm of film thickness at a wavelength of 365 nm.

8. The polymer optical wave guide according to claim 7, wherein
the cladding comprises an under-cladding present around the core at one side and an over-cladding present around the core at the opposite side to the under-cladding, and
at least one of the under-cladding and the over-cladding has a transmittance of 59% or more per 50 μm of film thickness at a wavelength of 365 nm.

9. The polymer optical wave guide according to claim 8, at least partially having a section at which one of the under-cladding and the over-cladding is not present and a core and the other cladding around the core are exposed, wherein
the other cladding in the section has a transmittance of 59% or more per 50 μm of film thickness at a wavelength of 365 nm.

10. The polymer optical wave guide according to claim 7, wherein
the curable composition of at least one of the core and the cladding comprises a fluorine-containing polyarylene prepolymer (A) having a crosslinkable functional group.

11. The polymer optical wave guide according to claim 10, wherein
the curable composition of the core comprises the fluorine-containing polyarylene prepolymer (A) having a crosslinkable functional group, and
the curable composition of the cladding comprises: the fluorine-containing polyarylene prepolymer (A) having a crosslinkable functional group; and a compound (B) having a molecular weight of 140 to 5,000, having a crosslinkable functional group, and having no fluorine atom.

12. The polymer optical wave guide according to claim 7, being a single-mode polymer optical waveguide.
